(19) United States
(12) Patent Application Publication
(10) Pub. No.: US 2005/0174547 A1
(43) Pub. Date: Aug. 11, 2005

(54) Image display apparatus and image display apparatus selection method

(76) Inventors: Shogo Yamaguchi, Kanagawa-ken (JP); Shinya Murai, Kanagawa-ken (JP)

Correspondence Address: Finnegan, Henderson, Farabow,;Garrett & Dunner, L.L.P., 1300 I Street, N.W., Washington, DC, 20005-3315, US

(21) Appl. No.: 10/947,229

(22) Filed: Sep. 23, 2004

(30) Foreign Application Priority Data
Sep. 24, 2003 (JP) 2003-332104

(51) Int. Cl. G03B 21/00; G03B 21/26; G03B 19/18; G06F 15/16

(52) U.S. Cl. 353/122; 353/30; 353/94; 352/133; 709/227

(57) ABSTRACT

The present invention makes it easier to select, when there are plural image display apparatuses such as projectors, a display destination image display apparatus. The embodiment of the invention also prevents display on a wrong image display apparatus. discriminating identifiers that are easy for a user to visually discriminate are given, separately from communication identifiers, to the image display apparatuses, and the user selects an image display apparatus on which an image is to be displayed while the user checks images relating to the discriminating identifiers that each image display apparatus displays. The embodiment of the invention is disposed with detecting overlaps between the image display apparatuses so that the discriminating identifiers do not overlap.

### CROSS-REFERENCE TO RELATED APPLICATION

This application claims the benefit of priority under 35 USC §119 from Japanese Patent Application No. 2003-332104, filed on Sep. 24, 2003, the entire disclosure of which is incorporated by reference herein.

### BACKGROUND OF THE INVENTION

1. Field of the Invention

The present invention relates to an image display apparatus that displays an image on a display unit such as a television or projector that projects an image.

2. Description of the Related Art

In recent years, as a result of the spread of apparatuses that project an image such as a projector, there are many instances where presenters use their own laptop computers to directly project electronic data and give presentations. Moreover, projectors themselves are becoming increasingly inexpensive and compact, and opportunities to utilize them not only at large conferences but also at conferences attended by small groups of people are increasing. Projectors and large-screen televisions widely used at present are connected by cables called RGB cables to personal computers (PCs) and personal digital assistants (PDAs) that send images.

The places where a projector can be disposed so that everyone can easily see the images shown are naturally limited. For this reason, every time that the screen onto which a projector projects the images is set, it is necessary to move to the place where the projector is disposed, which is removed from the position of the presenter. Moreover, when several people share a projector, it becomes necessary to switch cables each time a personal computer is connected to the projector with a cable. In order to eliminate this inconvenience, projectors that can be wirelessly connected to a personal computer have recently come to be marketed.

However, when wireless technology is used, it is impossible to select the projection destination projector as when the projector is physically connected to a personal computer with a cable. For this reason, there has been the drawback that, when there are plural projectors, image information ends up being projected by an unintended projector.

For this reason, in the information output apparatus disclosed in Japanese Patent Application Publication (kokai) No. 2002-218420, identification information is projected on a screen, and image information that a user wishes to display is transmitted together with this identification information from a PC transmitting the image. Similar to this information output apparatus, there are also apparatuses that determine whether or not information is image information that has been transmitted to those apparatuses.

With methods of inputting identification information of individual projectors that is displayed on an image comprising character strings given in order to identify apparatuses in advance, and with methods of prompting a user to input apparatus identification information comprising lists of numbers such as in MAC addresses given to projectors in advance to make them unique, it is difficult to input the identification information and easy to erroneously input the identification information. This is because, when identification information is given at the shipping stage to projectors manufactured in large quantities, there end up being many digits in the identification information. This is also because the identification information ends up becoming lists of meaningless characters that are difficult for users to understand.

### SUMMARY OF THE INVENTION

The embodiment of the present invention was made to enable a user to be able to visually grasp the image display apparatus with which the user wants to display an image when there are plural image display apparatuses such as projectors. The embodiment of the invention provides an image display apparatus and an image display system that are configured to ensure that an image does not end up being outputted to an image display apparatus to which the image is not to be outputted.

An aspect of the image display apparatus pertaining to the invention is an image display apparatus that is used in a presentation and which receives and displays image information to be displayed from another communication apparatus on a network, the image display apparatus comprising: image displaying unit configured to display the received image information; discriminating identifier setting unit configured to set discriminating identifiers for identifying the image display apparatuses displayable on the image displaying unit, the discriminating identifier that is visually identifiable from other discriminating identifiers that other image display apparatuses display, if the image displaying unit displays; image generating unit configured to generate an identification image that is displayable on the image displaying unit and represents the discriminating identifier set by the discriminating identifier setting unit; and controller configured to cause the image displaying unit to display the identification image that the image generating unit has generated.

An aspect of the image display system pertaining to the invention is an image display system for a presentation comprises an image transmission apparatus connectable on a network and an image display apparatus that receives and displays image information to be displayed from the image transmission apparatus: wherein the image display apparatus includes image displaying unit configured to display the received image information, discriminating identifier setting unit configured to set discriminating identifiers for identifying the image display apparatuses displayable on the image displaying unit, the discriminating identifier that is visually identifiable from other discriminating identifiers that other image display apparatuses display, if the image displaying unit displays, identifier information transmitting unit configured to transmit, to at least image display apparatuses connectable on the network, identifier information including the discriminating identifier that the discriminating identifier setting unit has set, image generating unit configured to generate an identification image that is displayable on the image displaying unit and represents the discriminating identifier set by the discriminating identifier setting unit, and controller configured to cause the image displaying unit to display the identification image that the image generating unit has generated; the image transmission apparatus includes identifier information receiving unit configured to receive the identifier information that the image display apparatus has transmitted, display unit configured to associate and display identification expressing the discriminating identifier included in the identifier information received by the identifier information receiving unit and an identifier representing the image display apparatus that has transmitted the identifier information, and input unit configured to select and input, from the display of the display unit, the image display apparatus serving as the transmission destination of the image information to be displayed in the presentation; and the input unit selects the image display apparatus serving as the transmission destination by selecting an image display apparatus where the identification expressing the discriminating identifier that the display unit has displayed and the recognition of the identification image that the controller caused the image displaying unit to display are the same.

### BRIEF DESCRIPTION OF THE DRAWINGS

FIG. 1 is a diagram showing an aspect of an image display system pertaining to a first embodiment of the invention;

FIG. 2 is a block diagram showing an aspect of an image display apparatus pertaining to the first embodiment;

FIG. 3 is a block diagram showing an aspect of an image transmission apparatus pertaining to the first embodiment;

FIG. 4 is a diagram showing an aspect of a processing flow of the image display apparatus pertaining to the first embodiment;

FIG. 5 is a diagram showing an aspect of a processing flow of the image transmission apparatus pertaining to the first embodiment;

FIG. 6 is a diagram showing an aspect of the disposition of the image display system pertaining to the first embodiment;

FIGS. 7(a) and 7(b) are diagrams showing an aspect of operation screens in the image display system pertaining to the first embodiment;

FIG. 8 is a diagram showing an aspect of the disposition of the image display system pertaining to the first embodiment;

FIG. 9 is a block diagram showing an aspect of an image display apparatus pertaining to a modified aspect of the first embodiment;

FIG. 10 is a block diagram showing an aspect of an image transmission apparatus pertaining to a second embodiment of the invention;

FIG. 11 is a diagram showing an aspect of a processing flow of an image display apparatus pertaining to the second embodiment; and

FIG. 12 is a diagram showing an aspect of a processing flow of the image transmission apparatus pertaining to the second embodiment.

### DETAILED DESCRIPTION OF THE INVENTION

### First Embodiment

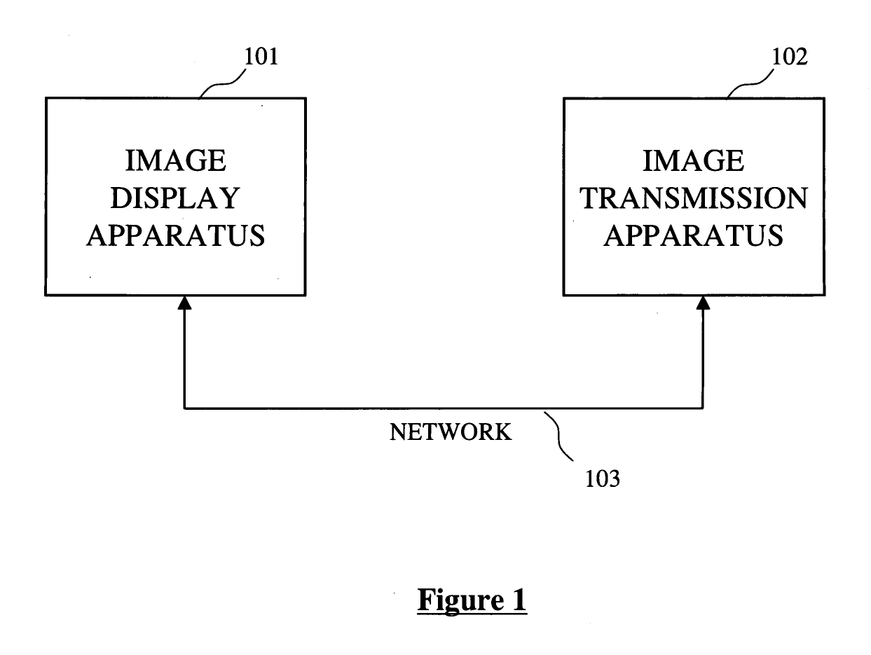

FIG. 1 shows an example of an image display system pertaining to a first embodiment of the invention. FIG. 1 shows an image display apparatus 101, an image transmission apparatus 102 and a network 103. The image display apparatus 101 is a apparatus such as a projector or large-screen television that displays image information so that a large number of people can view the image information. The image transmission apparatus 102 is an apparatus such as a PC or PDA that includes the function of transmitting, as the result of operation by a user, the image information to be displayed on the image display apparatus 101. Ordinarily, the image display apparatus 101 is disposed in a place removed from the presenter who is the user. For this reason, the user seldom gives a presentation while directly operating the image display apparatus 101; rather, the user gives a presentation while mainly operating the image transmission apparatus 102. The image display apparatus 101 and the image transmission apparatus 102 are connected to the network 103 so that the image display apparatus 101 and the image transmission apparatus 102 can communicate with each other. In the present embodiment, it is supposed that the network 103 is a wireless LAN conforming to the IEEE802.11b standard or a network conforming to a communication standard whose purpose is close-range communication. The network 103 may also be one according to a communication format other than the communication standards mentioned above as long as the network 103 is one where at least the image transmission apparatus 102 is communicably connected to plural image display apparatuses 101.

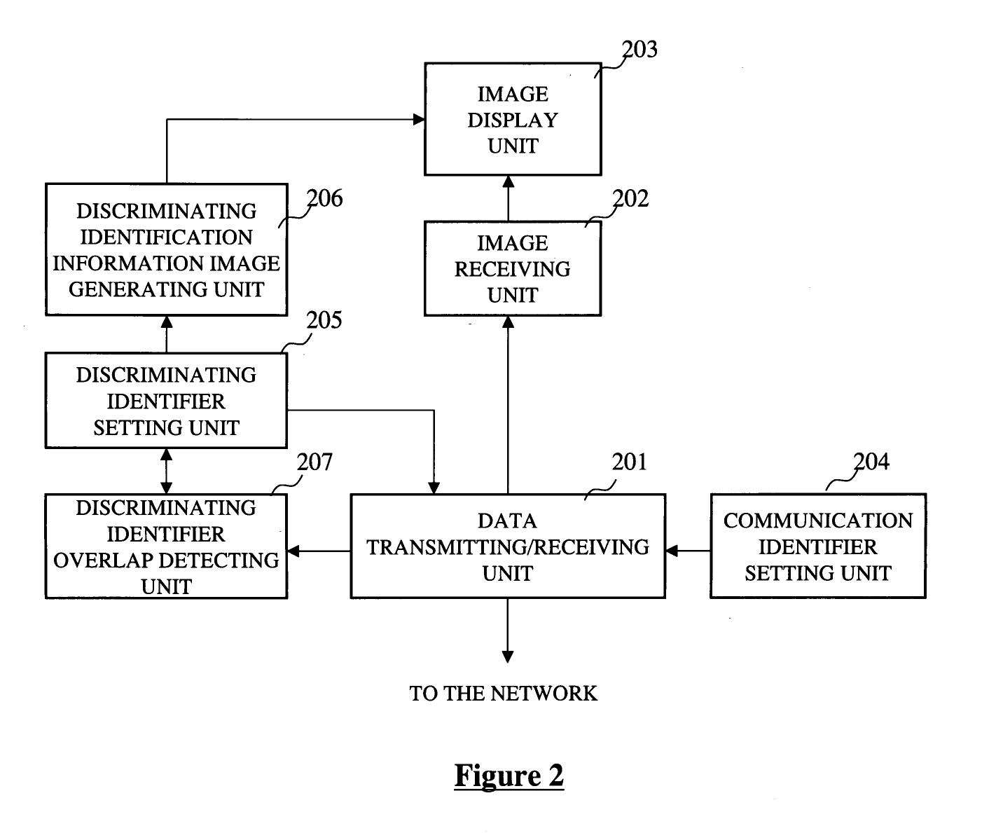

FIG. 2 is a block diagram showing an example of the image display apparatus 101 pertaining to the present invention.

As shown in FIG. 2, the image display apparatus 101 includes a data transmitting/receiving unit 201, an image receiving unit 202, an image display unit 203, a communication identifier setting unit 204, a discriminating identifier setting unit 205, a discriminating identification information image generating unit 206 and a discriminating identifier overlap detecting unit 207.

The data transmitting/receiving unit 201 includes the function of transmitting data to and receiving data from other communication apparatuses via the network 103.

The image receiving unit 202 includes the function of receiving image information from other communication apparatuses via the data transmitting/receiving unit 201. The image receiving unit 202 may also be disposed with the function of processing or editing the received image information into an easy-to-display format. The image receiving unit 202 transfers the received image information to the image display unit 203.

The image display unit 203 includes the function of displaying the image information transferred from the image receiving unit 202. For example, if the image display apparatus is a projector, the image display unit 203 corresponds to an optical system that projects an image, and if the image display apparatus is a large-screen television, the image display unit 203 corresponds to a Braun tube, a liquid crystal display or a plasma display. The image display unit 203 also displays various types of information by superposing those types of information on the received image information or displays those types of information separately from the received image information.

The communication identifier setting unit 204 includes the function of setting an identifier for identifying its own image display apparatus, which becomes necessary when transmitting data to and receiving data from another communication apparatus via the network 103. For example, when TCP/IP is used for the communication protocol, an IP address can be used for the communication identifier. Alternatively, when communicating directly by a data link layer, a MAC address can also be used as the communication identifier. The communication identifier setting unit 204 may be configured so that the user manually sets the identifier or so that the identifier is automatically set using the DHCP (Dynamic Host Configuration Protocol) that is used to set IP addresses. The communication identifier setting unit 204 may also be configured so that the address is automatically set within an address range as in Auto-IP.

The discriminating identifier setting unit 205 includes the function of setting a discriminating identifier that is separate from the communication identifier and is disposed so that the user can easily identify each image display apparatus 101. For example, when the image display apparatus 101 is started, the discriminating identifier setting unit 205 generates a new discriminating identifier and sets that as the image display apparatus's own discriminating identifier.

After being set, the discriminating identifier is transmitted to other communication apparatuses on the network 103 via the data transmitting/receiving unit 201. The discriminating identifier may be periodically broadcasted on the network 103, or may be transmitted when there is a request from another communication apparatus to notify that communication apparatus of the image display apparatus's discriminating identifier.

Examples of the discriminating identifier, which is disposed so that the user can easily identify each image display apparatus 101, include colors, character strings or numerical strings of one to two characters that have been enlarged for easy viewing (e.g., “A”, “B”, “1”, “2”, etc.), figures, meaningful character strings and meaningful images. When a color is used as the discriminating identifier, visually and mutually identifiable color information—e.g., intuitively perceivable colors such as “red”, “blue” and “yellow”—is appropriate. When a figure is used as the discriminating identifier, the figure should be easily identifiable, such as a circle, square, triangle, or a combination thereof. Even when a meaningful character string or image is adopted, it is best for the character string or image to be one with a clear meaning so that differences in the perception of things which each user associates with the same character string or image do not arise (e.g., “fish”, “elephant”, etc.). By using such discriminating identifiers, the perception of each identifier by each user is facilitated and the selection of the image display apparatus 101 on the image transmission apparatus 102 is facilitated. These discriminating identifiers may also be combined as long as the user is not confused by them.

The discriminating identification information image generating unit 206 includes the function of receiving, from the discriminating identifier setting unit 205, the discriminating identifier set as its own apparatus's discriminating identifier, and generating user identification information that is easy for the user to recognize when the discriminating identifiers are displayed on the image display unit 203. The discriminating identification information in this case is an image displayable on the image display unit 203. The generated image is sent to the image display unit 203.

If the discriminating identifier sent from the discriminating identifier setting unit 205 relates to a color, the discriminating identification information image generating unit 206 generates an image having a color region appropriate to that color. Similar to the figure, character string or meaningful image, the discriminating identification information image generating unit 206 generates an image that the user can be expected to recognize when the user sees the image.

The discriminating identifier overlap detecting unit 207 includes the function of detecting an overlap between another discriminating identifier and its apparatus's own discriminating identifier set by the discriminating identifier setting unit 205 when the discriminating identifier overlap detecting unit 207 receives a discriminating identifier that another image display apparatus 101 has transmitted via the data transmitting/receiving unit 201, or when the discriminating identifier overlap detecting unit 207 receives a response (overlap notification) with respect to a request it has issued to notify its own apparatus of the discriminating identifier, or when the discriminating identifier overlap detecting unit 207 directly receives an overlap notification from another communication apparatus. When the discriminating identifier overlap detecting unit 207 detects that its apparatus's discriminating identifier overlaps with (i.e., is the same as) the discriminating identifier of another image display apparatus 101, it instructs the discriminating identifier setting unit 205 to reset its apparatus's discriminating identifier so that the overlap is eliminated. The discriminating identifier overlap detecting unit 207 may also be configured to initially determine whether or not to request resetting. This determination may be done by comparing the communication identifier of another image display apparatus 101 with its own communication identifier, which overlap, or may be done so that only the smaller image display apparatus resets the discriminating identifier. Alternatively, determination of the necessity of resetting may also be conducted per image display apparatus in accordance with random numbers and probability.

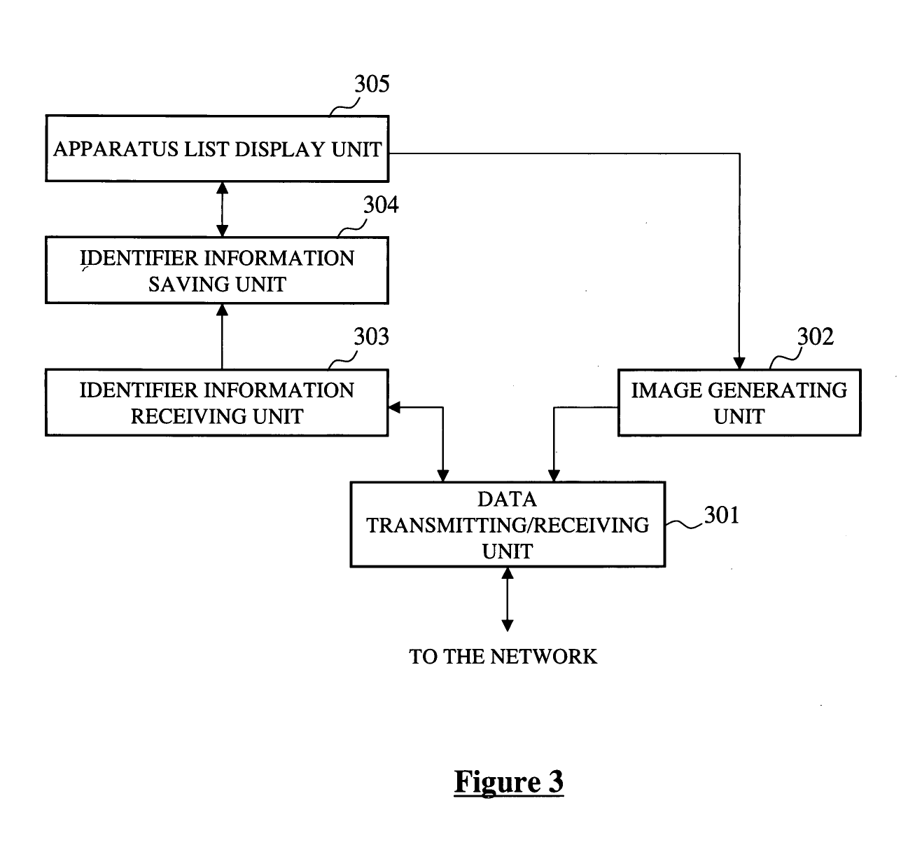

FIG. 3 is a block diagram showing an example of the image transmission apparatus 102 pertaining to the present embodiment.

As shown in FIG. 3, the image transmission apparatus 102 includes a data transmitting/receiving unit 301, an image generating unit 302, an identifier information receiving unit 302, an identifier information saving unit 304 and a apparatus list display unit 305.

The data transmitting/receiving unit 301 includes the function of communicating with other communication apparatuses on a network via the network 103.

The image generating unit 302 includes the function of generating image information to be displayed on the image display apparatus 101 via the data transmitting/receiving unit 301. The generated image may be the screen of a PC or PDA that is transferred to the image display apparatus 101, or a may be a virtual screen. The image generating unit 302 may also be configured to generate image information that is to be displayed on the basis of an image file stored in the image transmission apparatus 102. The image generating unit 302 can also be configured to change the method of generating the image information in accordance with the attributes of the transmission destination image display apparatus 101. For example, in a case where the capacity of the image display apparatus 101 to store information is small, the image generating unit 302 can generate and transmit image information of a smaller size. Alternatively, in a case where the networks 103 connected to each image display apparatus 101 are different, the image generating unit 302 can make the image information into a size suited for the respective transfer capacities of the networks.

The identifier information receiving unit 303 extracts, from a packet including the identifier that the data transmitting/receiving unit 301 has received, the communication identifier and the discriminating identifier of the transmission source transmitting the packet. The extracted communication identifier and discriminating identifier are transferred to the identifier information saving unit 304 in order to save them as identifier information of one image display apparatus 101.

In this case, the identifier information receiving unit 303 checks for overlaps between the identifier information of another image display apparatus 101 saved in the identifier information saving unit 304 and the identifier information previously extracted for saving. When there are discriminating identifiers that are the same but the communication identifiers are different, the identifier information receiving unit 303 generates an overlap notification indicating that the discriminating identifiers overlap. The generating overlap notification is transmitted to another image display apparatus 101 via the data transmitting/receiving unit 301.

The identifier information saving unit 304 includes the function of saving the identifier information received from the identifier information receiving unit 303. In a case where the same identifier information has already been saved, the identifier information saving unit 304 does not save the new identifier information. However, in a case where there is identifier information where the communication identifiers are the same and the discriminating identifiers are different, the identifier information saving unit 304 saves the newly received identifier information as the identifier information of the image display apparatus 101 having that communication identifier.

The apparatus list display unit 305 includes the function of displaying, as a list, the image display apparatuses 101 whose identification information is saved in the identifier information saving unit 304. The image display apparatuses 101 are displayed in conformity with the discriminating identifiers included in the identifier information. For example, the apparatus list display unit 305 displays in red a display corresponding to an image display apparatus 101 whose discriminating identifier is the color “red”. In the case of a figure, the apparatus list display unit 305 displays a “circle” near the display corresponding to the relevant image display apparatus 101. In this manner, the apparatus list display unit 305 displays the list so that the relation between each image display apparatus 101 and its given discriminating identifier is easy to understand. The user selects, from the list displayed on the apparatus list display unit 305, the image display apparatus 101 on which the user wants to display an image. The image generating unit 302 is notified of the information of the selected image display unit 101.

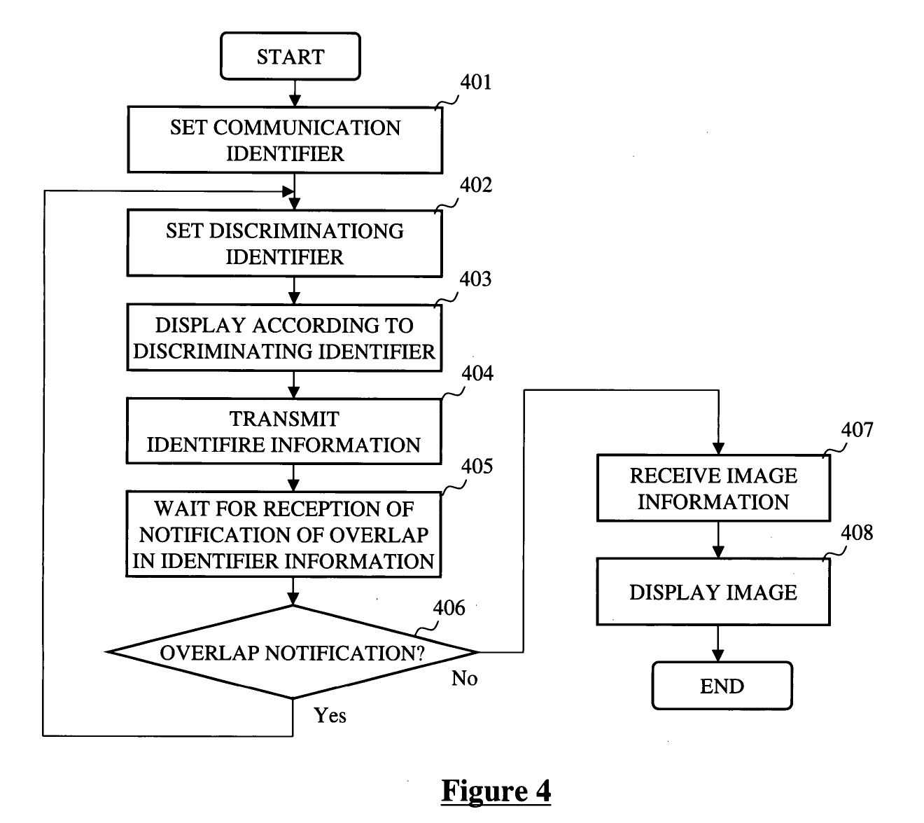

FIG. 4 is a diagram showing an example of a processing flow when the image display apparatus 101 pertaining to the present embodiment is started.

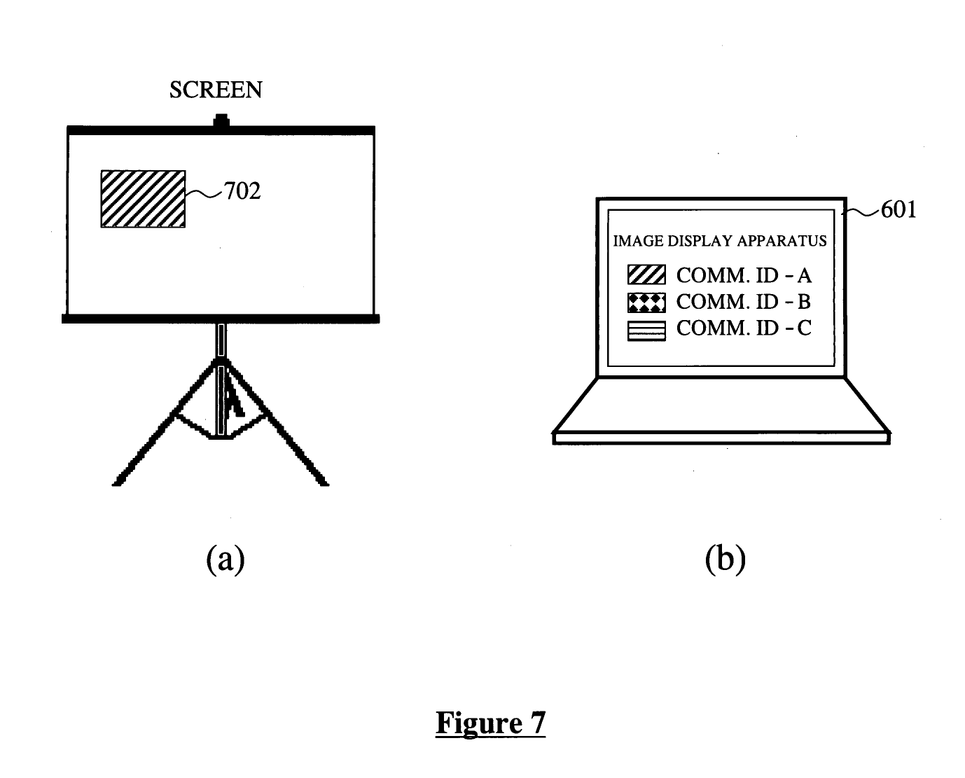

First, the communication identifier of an image display apparatus is set by that apparatus's communication identifier setting unit 204 (step 401). Next, the discriminating identifier is set by that apparatus's discriminating identifier setting unit 205 (step 402). The discriminating identifier may be newly generated each time the apparatus is started, or in a case where the previously used discriminating identifier has been stored, a discriminating identifier that is the same as the previous one may be used. Here, the set discriminating identifier is sent to the discriminating identification information image generating unit 206, where an image of a format displayable on the image display unit 203 is generated and displayed on the image display unit 203 (step 403). FIG. 7(a) shows an example of the display when the discriminating identifier information here is represented by a color. This is a case where the image display apparatus 101 is a projector, and shows an example where an image is projected onto a disposed screen. “Red (shaded in diagonal lines)” is projected in a display region 701 of a screen onto which the image display apparatus 101 is projecting. In other words, this means that the color “red” is given to the image display apparatus 101 as the discriminating identifier.

Next, the communication identifier set by the communication identifier setting unit 204 and the discriminating identifier set by the discriminating identifier setting unit 205 are transmitted to other communication apparatuses on the network 103 (step 404). This is done in order to notify the other communication apparatuses of the apparatus's own identifier information and confirm that the identifiers do not overlap. The identifier information is transmitted by broadcasting because the transmission destinations are not clear.

After the identifier information has been transmitted, the image display apparatus waits for an overlap notification indicating whether or not there is an overlap between that apparatus's identifier information and the identifier information of other image display apparatuses 101 (step 405). Here, when there is an overlap notification from the image transmission apparatus 102 indicating that the identifier information overlaps with that of another image display apparatus 101 (step 406), the discriminating identifier is reset and the series of operations is repeated.

In a case where there is no overlap notification even after waiting a predetermined amount of time, it is determined that there is no overlap in the identifier information and the current identifier information is used (step 406). In a case where image information is transmitted from the image transmission apparatus 102, the image information is received (step 407) and displayed (step 408).

The processing flow shown in FIG. 4 is one example. The processing may also be configured so that, before it is determined whether or not the identifier information overlaps, the image information is received and displayed immediately after the setting of the identifiers. Even in a case where the image information is being displayed, an overlap may be cancelled at the stage where it is ascertained that there is an overlap.

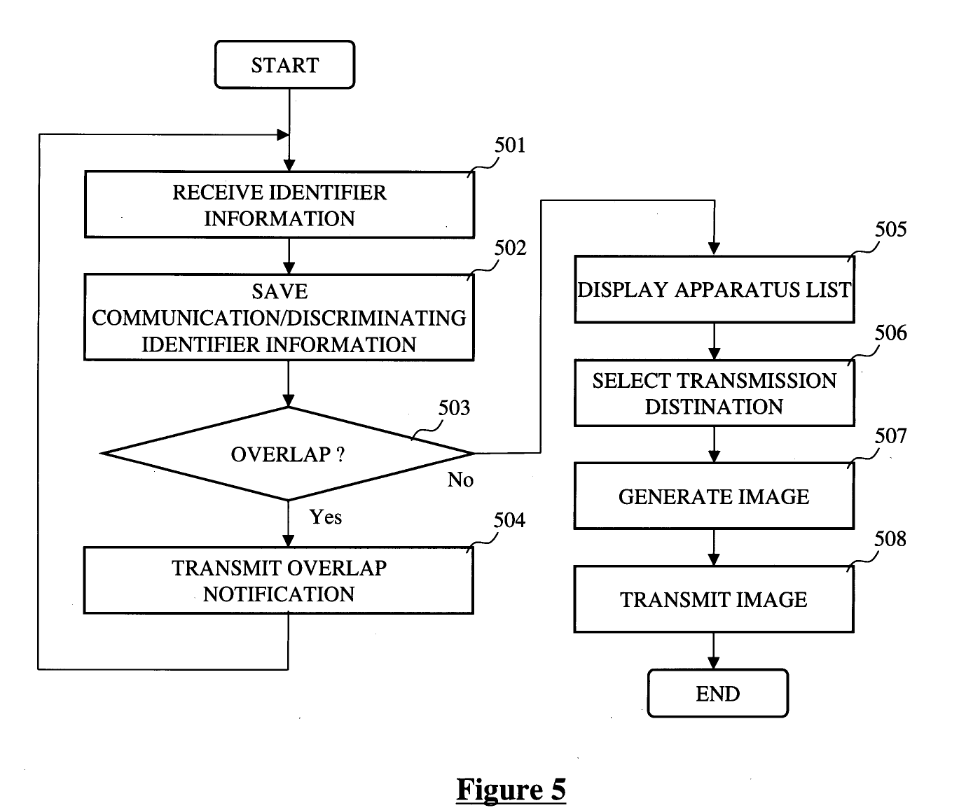

FIG. 5 is a diagram showing an example of a processing flow when the image transmission apparatus 102 pertaining to the present embodiment is started.

When the image transmission apparatus receives the identifier information that the image display apparatus 101 has transmitted (step 501), the image transmission apparatus saves the received identifier information in the identifier information saving unit 304 (step 502). When the received identifier information is the same as identifier information that has already been saved, the image transmission apparatus does not save the received identifier information. When the identifier information is such that the communication identifier is the same and the discriminating identifier is different, the image transmission apparatuss determines that the discriminating identifier given to the image display apparatus 101 having this communication identifier has been changed, and changes the saved content to the content of the newly received identifier information.

When identifier information where the discriminating identifier is the same despite the fact that the communication identifier of the identifier information received by the identifier information receiving unit 303 is different has already been saved in the identifier information saving unit 304, the image transmission apparatus determines that the discriminating identifier overlaps with the discriminating identifier of another image display apparatus 101 (step 503) and transmits, to at least one of the image display apparatuses 101 whose discriminating identifiers overlap, an overlap notification indicating that the discriminating identifier overlaps (step 504). After the transmission, the image transmission apparatus again tries to receive the identifier information in order to determine whether or not the overlapping of the discriminating identifiers has been eliminated.

In step 503, when the image transmission apparatus determines that the discriminating identifiers do not overlap in any of the image display apparatuses 101, the apparatus list display unit 305 creates and displays the apparatus list on the basis of the identifier information saved in the identifier information saving unit 304 (step 505). The apparatus list is displayed on the display apparatus with which the image transmission apparatus 102 is disposed.

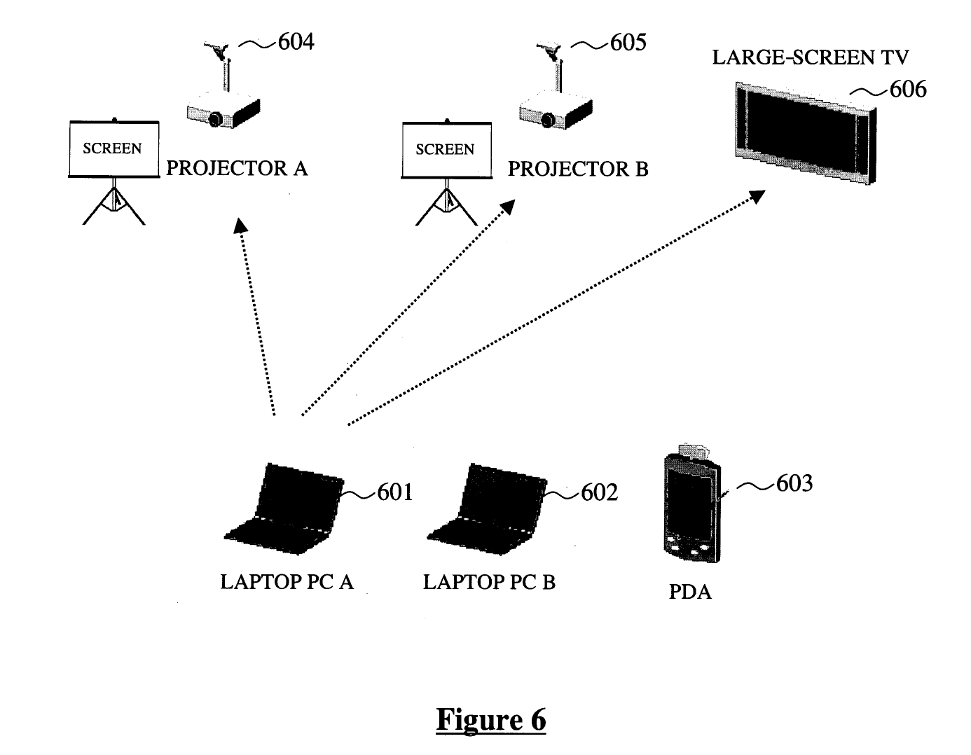

Here, as shown in FIG. 6, which is an example of the disposition of the image display system of the present embodiment, it will be assumed that there are a projector A604, a projector B605 and a large-screen television 606 serving as the image display apparatuses 101, and a laptop PC A601, a laptop PC B602 and a PDA 603 that are the image transmission apparatuses 102. It will be assumed that the laptop PC A601 can communicate with all three of the image display apparatuses 101 and is itself capable of display. The laptop PC A601 must be able to designate to which of the image display apparatuses it will transmit image information.

FIG. 7(b) shows an example of a screen display on a screen unit with which the laptop PC A601, which is one of the image transmission apparatuses 102, is disposed. A communication identifier A, a communication identifier B and a communication identifier C are selectably displayed as transmission destinations in the displayed apparatus list. The communication identifiers A, B and C respectively represent the projector A604, the projector B605 and the large-screen television 606. However, because the communication identifiers are strings of numbers and characters, it is difficult for the user to understand which communication identifiers represent which image display apparatuses. Thus, colors representing each image display apparatus are displayed next to the apparatuses in the apparatus list. It will be assumed that, in FIG. 7(b), patterns displayed at the left side of the apparatus list respectively correspond to “red”, “blue” and “yellow” from top to bottom. Assuming that the image projected by the projector A604 in FIG. 6 is the display shown in FIG. 7(a), the color of the display region 701 will be “red”. Thus, the user should select the communication identifier A in FIG. 7(b) in order to designate the projector displaying the display of FIG. 7(a) as the transmission destination. Even in a case where another image display apparatus is to be selected, the user should select, from the apparatus list displayed on the laptop PC A601, the communication identifier to which has been allocated the color representing the image display apparatus that the user wants to designate as the transmission destination.

The displays of FIGS. 7(a) and 7(b) are only examples. For instance, the method of selecting the display apparatus may also be one where the communication identifiers A, B and Care themselves displayed as designated colors. Alternatively, when displayable character strings or symbols are used as the discriminating identifiers, the displays of the communication identifiers A, B and C shown in FIG. 7(b) may be replaced with the discriminating identifiers so that the discriminating identifiers are displayed. Any method is applicable as long as it is one where it is possible to specify, even indirectly, whether the communication identifier of the image display apparatus 101 serving as the transmission destination is one of the communication identifiers A, B and C.

As described above, the user selects at least one apparatus from among the image display apparatuses 101 displayed on the apparatus list display unit 305 (step 506) and generates image information to be transmitted and displayed (step 507). After the image information is generated, the image transmission apparatus transmits the generated image information to the image display apparatus 101 selected in step 506 (step 508).

The processing flow shown in FIG. 5 is only one example. For instance, the invention may also be configured so that identifier information whose discriminating identifiers overlap is temporarily not displayed and then displayed in the apparatus list after the overlap has been eliminated.

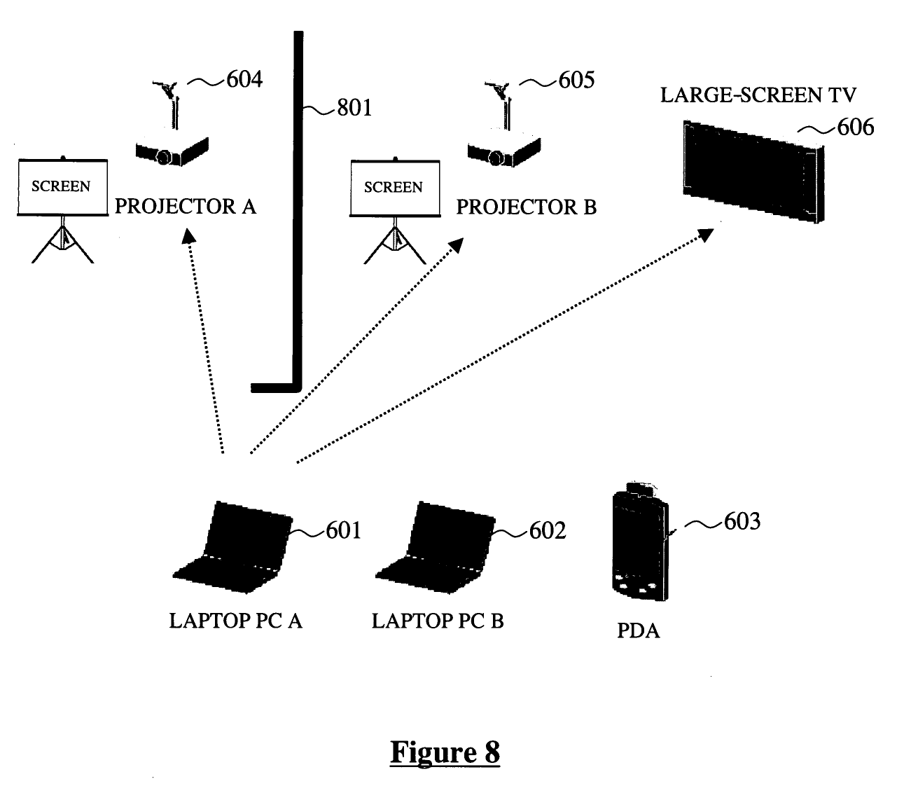

FIG. 8 is a diagram showing an example of the disposition, which is different from that of FIG. 6, of the image display system pertaining to the present embodiment. The difference between the disposition shown in FIG. 8 and the disposition shown in FIG. 6 is that, in the disposition of FIG. 8, the projector A604 cannot communicate with the projector B605 and the large-screen television 606 due to the presence of a barrier 801. In this case, the discriminating identifier overlap detecting unit 207 with which the image display apparatus 101 is disposed cannot conduct the discriminating identifier overlap detection in the series of steps 404, 405 and 406 shown in FIG. 4. Thus, there is the potential for the projector A604 to set a discriminating identifier that is the same as that of another image display apparatus 101 with which the projector A604 cannot communicate. At this point in time, the laptop PC A601 is in a position where it can communicate with each of the projector A604, the projector B605 and the large-screen television 606. Thus, the image display apparatuses 101 to which the same discriminating identifier has been given are still displayed in the apparatus list. Because the same discriminating identifiers cannot be eliminated, the user of the laptop PC A601 ends up being unable to discriminate between them. In the image display system pertaining to the present embodiment, the image transmission apparatus 102 that can communicate with the image display apparatus 101 having the overlapping discriminating identifier detects the overlap and transmits the overlap notification due to the processing of steps 503 and 504 shown in FIG. 5 of the identifier information receiving unit 303 with which the image transmission apparatus 102 is disposed, so that the same discriminating identifiers can be eliminated. Thus, in the image display system pertaining to the present embodiment, the overlap in the discriminating identifiers can be automatically eliminated even in a case such as shown in FIG. 8.

In the present embodiment, the invention is configured so that each image display apparatus 101 acquires the identifier information that the other image display apparatuss 101 have transmitted and so that the discriminating identifiers do not overlap. By configuring the invention in this manner, the discriminating identifiers can automatically be prevented from overlapping. Moreover, by configuring the invention so that the image display apparatuses 101 can be designated with the discriminating identifiers, it becomes easy for the user to designate the image display apparatus on which the user actually wants to display image information.

### MODIFIED EXAMPLE OF FIRST EMBODIMENT

The present modified example is one where an overlap display function is added to the image display apparatus 101 pertaining to the first embodiment.

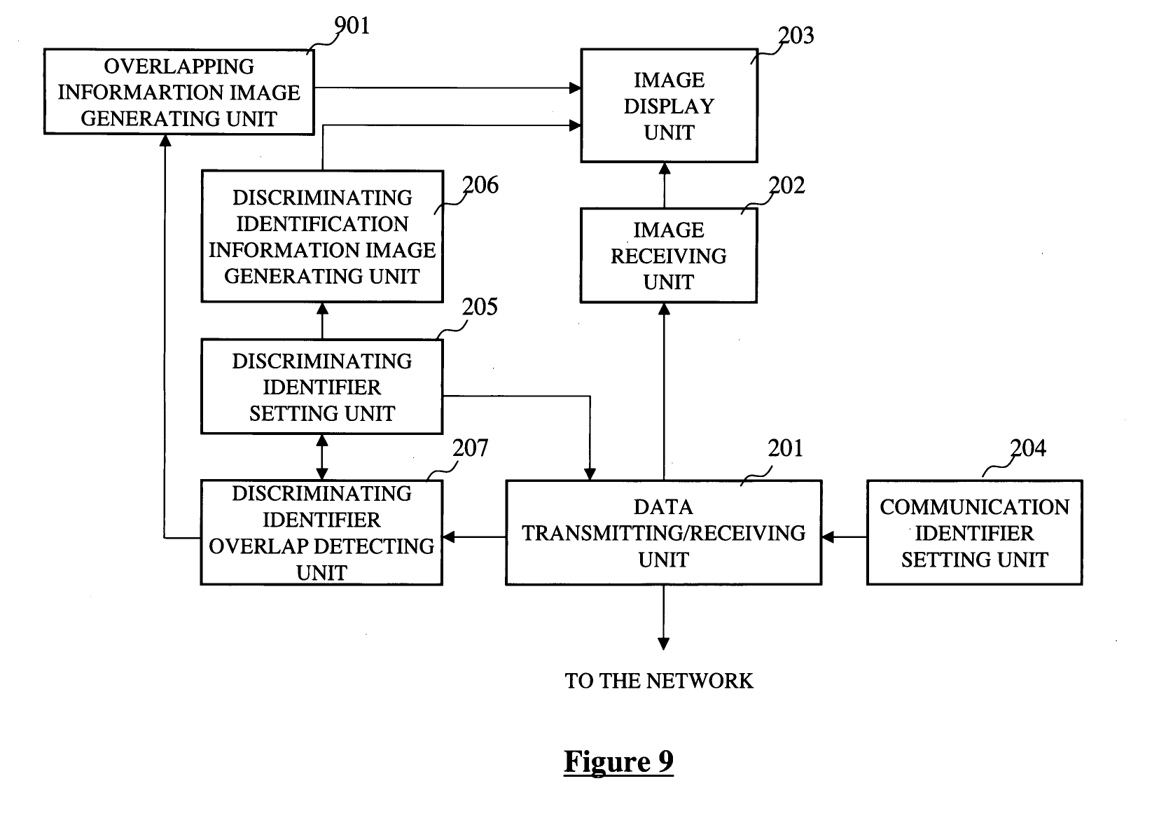

FIG. 9 is a block diagram showing an example of the image display apparatus 101 pertaining to the present modified example. In this modified example, an overlapping information image generating unit 901 is newly added.

The overlapping information image generating unit 901 receives the fact that the discriminating identifier overlap detecting unit 207 has detected an overlap in regard to the discriminating identifiers, and generates an image informing the user, through the image display unit 203, that the discriminating identifiers of the relevant image display apparatuses 101 overlap. The generated image may be characters or an image that draws the user's attention. When the image is displayed on the image display unit 203, it may be superposed on the image information if the image information is being displayed, or may be displayed separately from the image information.

As long as it is understood that the discriminating identifiers overlap as in the present modified example, the image display apparatus can automatically wait for the overlapping discriminating identifier to be eliminated. Thus, problems such as the image ending up being displayed on the wrong image display apparatus 101 can be avoided.

### Second Embodiment

Because much of the content of the present embodiment is the same as that of the first embodiment, only the parts that differ from the first embodiment will be described.

A block diagram showing an example of the image display apparatus pertaining to the present embodiment will also be omitted because it is the same as FIG. 2.

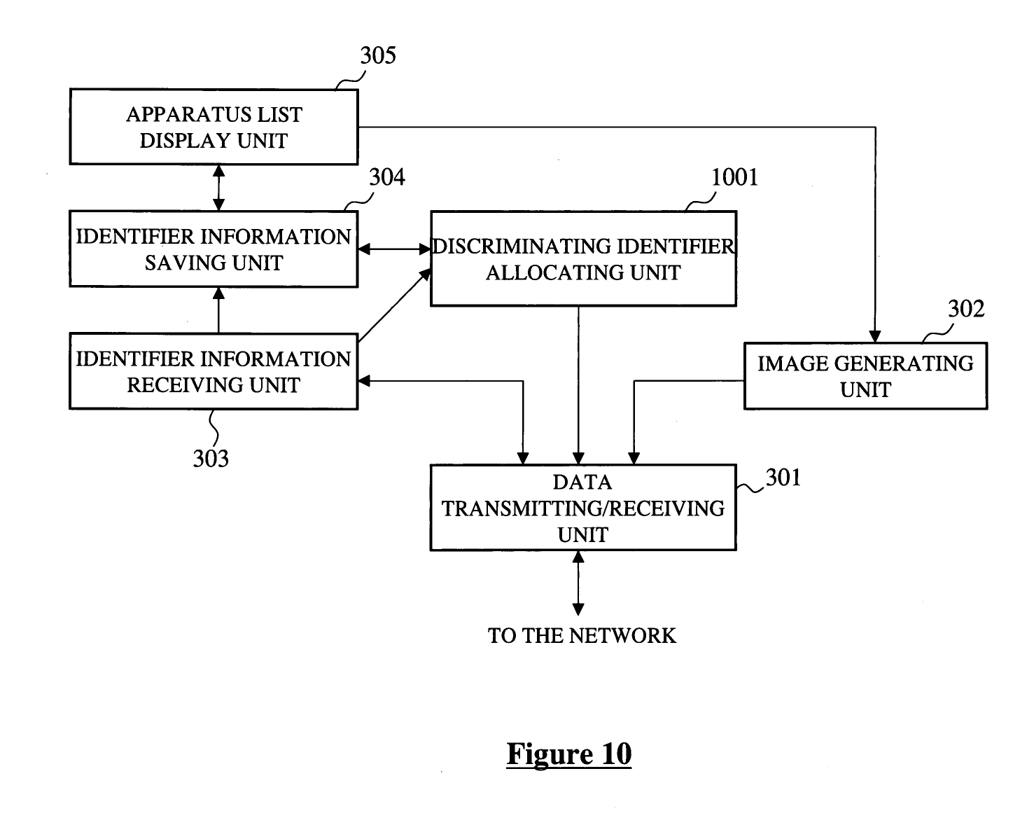

FIG. 10 is a block diagram showing an example of an image transmission apparatus 102 pertaining to the present embodiment. The difference between the image transmission apparatus shown in FIG. 10 and the image transmission apparatus pertaining to the first embodiment shown in FIG. 3 is that a discriminating identifier allocating unit 1001 is newly added to the image transmission apparatus shown in FIG. 10.

The discriminating identifier allocating unit 1001 includes the function of allocating discriminating identifiers to image display apparatuses 101 whose discriminating identifiers have not been set. When the discriminating identifier allocating unit 1001 is notified by the identifier information receiving unit 303 of that fact that there is an image display apparatus whose discriminating identifier has not been set, the discriminating identifier allocating unit 1001 generates and allocates a discriminating identifier with respect to that apparatus. In this case, by generating an identifier that does not overlap with the discriminating identifiers included in the identifier information already saved in the identifier information saving unit 304, the potential for the discriminating identifiers given to each of the image display apparatuses 101 to overlap can be reduced. The allocated discriminating identifier is transmitted as a discriminating identifier setting request via the data transmitting/receiving unit 301 to the image display apparatus 101 whose discriminating identifier has not been set.

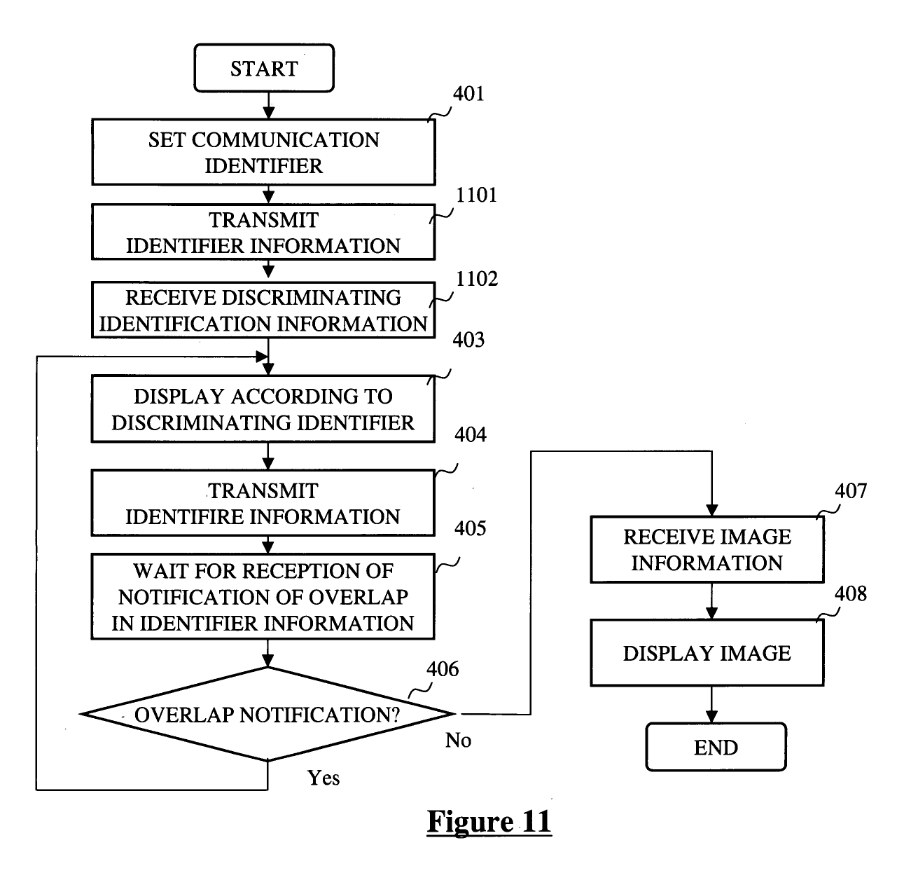

FIG. 11 is a diagram showing an example of a processing flow when the image display apparatus pertaining to the present embodiment is started.

The processing flow shown in FIG. 11 is different from the processing flow of the first embodiment shown in FIG. 4 in that, here, steps 1101, 1102 and 1103 are added. When the setting of the communication identifier ends after startup (step 401), the data transmitting/receiving unit 201 transmits identifier information comprising the communication identifier and the discriminating identifier, with the discriminating identifier remaining unset (step 1101). The identifier information is transmitted by broadcasting because the transmission destination is not clear. The image display apparatus receives the identifier information because a request to set the discriminating identifier is sent, together with the discriminating identifier that the image transmission apparatus 102 has generated, from the image transmission apparatus 102 receiving this identifier information (step 1102). The discriminating identifier setting unit 205 of the image display apparatus 101 receiving this sets the sent discriminating identifier as its own discriminating identifier (step 1103).

In a case where steps 403 through 405 are conducted in accordance with the allocated discriminating identifier and there is an overlap notification in regard to the allocated discriminating identifier (step 406), the discriminating identifier setting unit 205 generates a discriminating identifier in the same manner as in the first embodiment.

The image display apparatus 101 pertaining to the present embodiment does not itself allocate the discriminating identifier at least at the time of startup, but uses the discriminating identifier that the image transmission apparatus 102 receiving the unset identifier information has allocated.

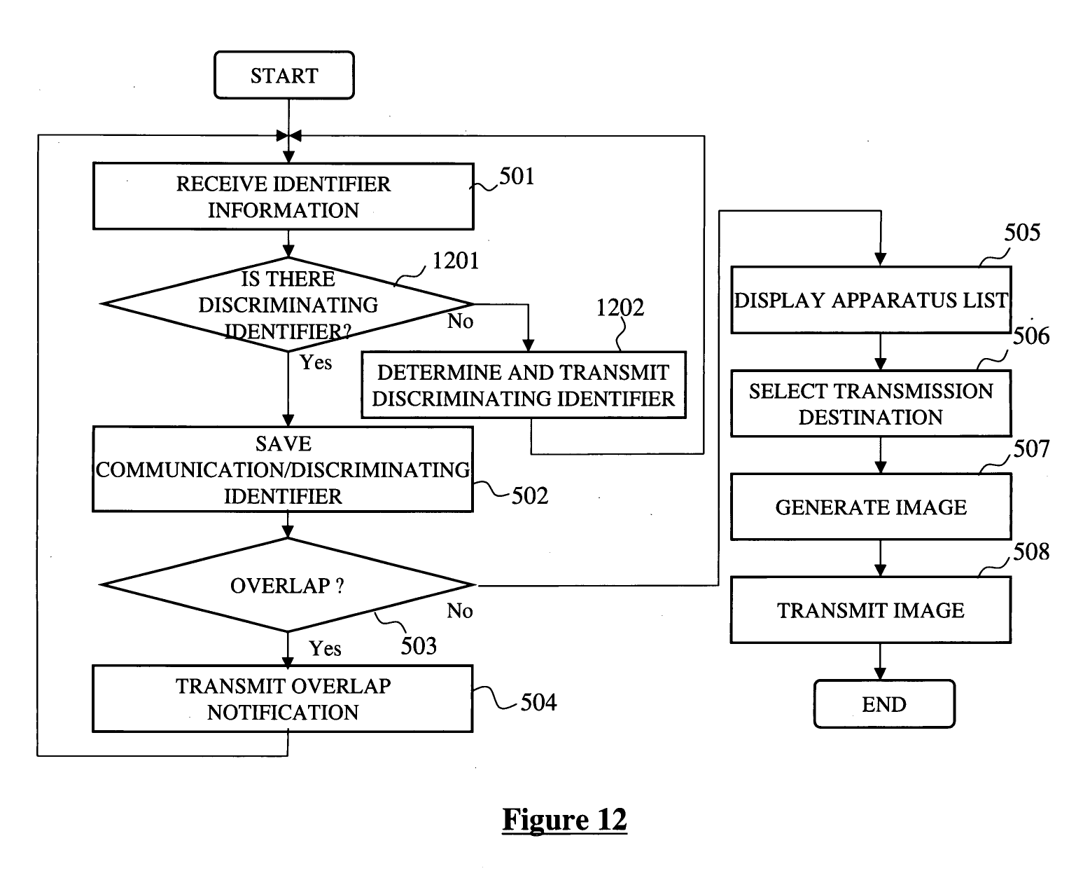

FIG. 12 is a diagram showing an example of a processing flow when the image transmission apparatus pertaining to the present embodiment is started.

The processing flow shown in FIG. 12 is different from the processing flow of the first embodiment shown in FIG. 5 in that, here, steps 1201 and 1202 are added. When the image transmission apparatus receives the identifier information that the image display apparatus 101 transmits (step 501), the identifier information receiving unit 303 determines whether or not the discriminating identifier included in the received identifier information is unset (step 1201). If the discriminating identifier is unset, the discriminating identifier allocating unit 1001 generates a discriminating identifier that does not overlap with the discriminating identifiers included in the identifier information stored in the identifier information saving unit 304 and transmits, as a request to set the discriminating identifier, the discriminating identifier to the image display apparatus 101 that transmitted the unset discriminating identifier via the data transmitting/receiving unit 301 (step 1202).

When there is an image display apparatus 101 indicating that its discriminating identifier is unset, the image transmission apparatus 102 pertaining to the present embodiment can allocate a discriminating identifier that does not overlap with those of other image display apparatuses 101.

The image transmission apparatus 102 of the present embodiment allocates discriminating identifiers in consideration of the discriminating identifiers of each image display apparatus 101. Thus, the image transmission apparatus 102 can ensure that the discriminating identifiers set when the image display apparatuses 101 are started do not overlap.

The present invention is not limited to the above-described embodiments. In each stage of implementation, the constituent elements can be modified and embodied within a range that does not deviate from the gist of the invention. Also, various inventions can be formed by appropriately combining the plural constituent elements disclosed in the above-described embodiments. For example, several constituent elements may be deleted from all of the constituent elements described in the embodiments. Moreover, the constituent elements of different embodiments may also be appropriately combined.

1. An image display apparatus for a presentation of image information received from a communication apparatus through a network, comprising:
image displaying unit configured to display the received image information;
discriminating identifier setting unit configured to set discriminating identifiers for identifying the image display apparatuses displayable on the image displaying unit, the discriminating identifier that is visually identifiable from other discriminating identifiers that other image display apparatuses display, if the image displaying unit displays;
image generating unit configured to generate an identification image that is displayable on the image displaying unit and represents the discriminating identifier set by the discriminating identifier setting unit; and
controller configured to cause the image displaying unit to display the identification image that the image generating unit has generated.

2. The image display apparatus of claim 1, wherein
the discriminating identifier comprises one of color information, figure information and words, or a combination thereof, and
the identification image that is generated by the image generating unit on the basis of the discriminating identifier and displayed by the image displaying unit is a color, a figure, characters, or a combination thereof.

3. The image display apparatus of claim 1, wherein the discriminating identifier setting unit sets a new discrimination identifier each time the image display apparatus is started.

4. The image display apparatus of claim 1, further comprising
identifier information transmitting unit configured to transmit, to communication apparatuses connectable on the network, identifier information including the discriminating identifier that the discriminating identifier setting unit has set,
identifier information receiving unit configured to receive the identifier information that another image display apparatus has transmitted, and
discriminating identifier overlap detecting unit configured to detect whether or not the discriminating identifier that the discriminating identifier setting unit has set overlaps with a discriminating identifier included in identifier information that another image display apparatus has transmitted and which the identifier information receiving unit has received,
wherein when the discriminating identifier overlap detecting unit determines that the discriminating identifier that the discriminating identifier setting unit has set overlaps with a discriminating identifier of another image display apparatus, the discriminating identifier overlap detecting unit instructs the discriminating identifier setting unit to reset a new discriminating identifier.

5. The image display apparatus of claim 1, further comprising overlapping information receiving unit configured to instruct the discriminating identifier setting unit to reset a new discriminating identifier, if it receives from another communication apparatus connectable on the network an overlap notification notifying the overlapping information receiving unit that the discriminating identifier that the discriminating identifier setting unit has set overlaps with that of another image display apparatus.

6. The image display apparatus of claim 1, further comprising
identifier information transmitting unit configured to transmit, to another communication apparatus connectable on the network, identifier information including information representing the fact that the discriminating identifier is unset, and
identifier setting request receiving unit configured to receive, from another communication apparatus connectable on the network, an identifier setting request including a request to set to a certain discriminating identifier,
wherein the identifier setting request receiving unit instructs the discriminating identifier setting unit to set the discriminating identifier included in the received identifier setting request to the discriminating identifier of the image display apparatus.

7. An image display system for a presentation comprises an image transmission apparatus connectable on a network and an image display apparatus that receives and displays image information to be displayed from the image transmission apparatus:
wherein the image display apparatus includes
image displaying unit configured to display the received image information,
discriminating identifier setting unit configured to set discriminating identifiers for identifying the image display apparatuses displayable on the image displaying unit, the discriminating identifier that is visually identifiable from other discriminating identifiers that other image display apparatuses display, if the image displaying unit displays,
identifier information transmitting unit configured to transmit, to at least image display apparatuses connectable on the network, identifier information including the discriminating identifier that the discriminating identifier setting unit has set,
image generating unit configured to generate an identification image that is displayable on the image displaying unit and represents the discriminating identifier set by the discriminating identifier setting unit, and
controller configured to cause the image displaying unit to display the identification image that the image generating unit has generated;
the image transmission apparatus includes
identifier information receiving unit configured to receive the identifier information that the image display apparatus has transmitted,
display unit configured to associate and display identification expressing the discriminating identifier included in the identifier information received by the identifier information receiving unit and an identifier representing the image display apparatus that has transmitted the identifier information, and
input unit configured to select and input, from the display of the display unit, the image display apparatus serving as the transmission destination of the image information to be displayed in the presentation; and
the input unit selects the image display apparatus serving as the transmission destination by selecting an image display apparatus where the identification expressing the discriminating identifier that the display unit has displayed and the recognition of the identification image that the controller caused the image displaying unit to display are the same.

8. The image display system of claim 7, wherein
the discriminating identifier comprises one of color information, figure information and words, or a combination thereof, and
the identification image that is generated by the image generating unit on the basis of the discriminating identifier and displayed by the image displaying unit is a color, a figure, characters, or a combination thereof.

9. The image display system of claim 7, wherein the discriminating identifier setting unit sets a new discriminating identifier each time the image display apparatus is started.

10. The image display system of claim 7, wherein the image display apparatus further includes
identifier information receiving unit configured to receive the identifier information that another image display apparatus has transmitted, and
discriminating identifier overlap detecting unit configured to detect whether or not the discriminating identifier that the discriminating identifier setting unit has set overlaps with a discriminating identifier included in identifier information that another image display apparatus has transmitted and which the identifier information receiving unit has received,
and when the discriminating identifier overlap detecting unit determines that the discriminating identifier that the discriminating identifier setting unit has set overlaps with a discriminating identifier of another image display apparatus, the discriminating identifier overlap detecting unit instructs the discriminating identifier setting unit to reset a new discriminating identifier.

11. The image display system of claim 7, wherein the image display apparatus further includes overlapping information receiving unit configured to instruct the discriminating identifier setting unit to reset a new discriminating identifier, if it receives from another communication apparatus connectable on the network an overlap notification notifying the overlapping information receiving unit that the discriminating identifier that the discriminating identifier setting unit has set overlaps with that of another image display apparatus.

12. The image display system of claim 7, wherein
the image transmission apparatus further includes
discriminating identifier allocating unit configured to generate a discriminating identifier to be allocated to the image display apparatus, and
identifier setting request transmitting unit configured to transmit, with respect to the image display apparatus, an identifier setting request requesting that the discriminating identifier of the image display apparatus be set to a certain discriminating identifier, and
the image display apparatus further includes identifier setting request receiving unit configured to receive the identifier setting request from the image transmission apparatus connectable on the network,
and before the discriminating identifier is set by the discriminating identifier setting unit
the identifier information transmitting unit transmits, to the image display apparatus connectable on the network, identifier information including information representing the fact that the discriminating identifier is unset,
and when the identifier receiving unit receives the identifier information where the discriminating identifier is unset,
the identifier request transmitting unit transmits the identifier setting request including the discriminating identifier allocated by the discriminating identifier allocating unit, and
the identifier setting request receiving unit instructs the discrimination identifier setting unit to set the discriminating identifier included in the received identifier setting request to the discrimination identifier of the image display apparatus.

13. A method of selecting image display apparatuses in an image display system for a presentation and comprises an image transmission apparatus connectable on a network and an image display apparatus that receives and displays image information to be displayed from the image transmission apparatus:
wherein the image display apparatus
setting discriminating identifiers for identifying the displayable image display apparatuses, that is visually identifiable from other discriminating identifiers that other image display apparatuses, if displayed,
transmitting, to at least image display apparatuses connectable on the network, identifier information including the set discriminating identifier, and
generating an identification image representing the set discriminating identifier, and
displaying the generated identification image;
the image transmission apparatus
receiving the identifier information that the image display apparatus has transmitted,
associating and displays identification expressing the discriminating identifier included in the received identifier information and an identifier representing the image display apparatus that has transmitted the identifier information, and
selecting, from the display, the image display apparatus serving as the transmission destination of the image information that is to be displayed in the presentation by selecting an image display apparatus where the identification expressing the discriminating identifier and the recognition of the displayed identification image are the same.

14. The image display apparatus selection method of claim 13, wherein the discrimination identifier comprises one of color information, figure information and words, or a combination thereof, and the identification image that is generated on the basis of the discrimination identifier and displayed is a color, a figure, characters, or a combination thereof.

15. A program of an image display apparatus that is used in a presentation and which receives and displays image information to be displayed from another communication apparatus on a network, the program comprising the steps of:
displaying the received image information;
setting discriminating identifier that is visually identifiable from other discriminating identifiers that other image display apparatuses display, if the discriminating identifiers for identifying the image display apparatuses are displayed;
generating a displayable identification image representing the set discriminating identifier; and
displaying the identification image.

16. The image display apparatus program of claim 15, wherein the discriminating identifier comprises one of color information, figure information and words, or a combination thereof, and the identification image that is generated on the basis of the discriminating identifier and displayed is a color, a figure, characters, or a combination thereof.

17. The image display apparatus program of claim 15, wherein the discriminating identifier is newly set each time the image display apparatus is started.

18. The image display apparatus program of claim 15, further comprising the steps of transmitting, to communication apparatuses connectable on the network, identifier information including the set discriminating identifier, receiving the identifier information that another image display apparatus has transmitted, and detecting whether or not the set discriminating identifier overlaps with a discriminating identifier included in the received identifier information, wherein when the detecting step determines that the set discriminating identifier overlaps with a discriminating identifier of another image display apparatus, a new discriminating identifier is reset.

19. The image display apparatus program of claim 15, further comprising the step of receiving, from another communication apparatus connectable on the network, an overlap notification giving notification that the set discriminating identifier overlaps with that of another image display apparatus, wherein when the overlap notification is received in this step, a new discriminating identifier is reset.

20. The image display apparatus program of claim 15, further comprising the steps of transmitting, to another communication apparatus connectable on the network, identifier information including information representing the fact that the discriminating identifier is unset, and receiving, from another communication apparatus connectable on the network, an identifier setting request including a request to set to a certain discriminating identifier, the discriminating identifier included in the received identifier setting request is used as the discriminating identifier of the image display apparatus.
